(19) United States
(12) Patent Application Publication
(10) Pub. No.: US 2011/0018461 A1
(43) Pub. Date: Jan. 27, 2011

(54) METHOD FOR PRODUCING A HIGH-PRESSURE DISCHARGE LAMP, METHOD FOR PRODUCING LIGHT USING A HIGH-PRESSURE DISCHARGE LAMP AND DIGITAL VIDEO PROJECTOR

(75) Inventors: Swen-Uwe Baacke, Neuburg/Donau (DE); Gerhard Loeffler, Eichstaett (DE); Dirk Rosenthal, Gaimersheim (DE); Wolfgang Seitz, Eichstaett (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/935,614

(22) PCT Filed: Apr. 1, 2008
(86) PCT No.: PCT/EP2008/053873

§ 371 Date: Sep. 30, 2010

(51) Int. Cl. H05B 41/36; H01J 9/00

(52) U.S. Cl. 315/291; 445/26

(57) ABSTRACT

A method for providing a high-pressure discharge lamp may include establishing a setpoint power of the high-pressure discharge lamp, establishing an upper limit Iₘₐₓ in A for the current intensity of the current with which the high-pressure discharge lamp is intended to be operated with respect to the setpoint power, and constructing a high-pressure discharge lamp, wherein a cathode and an anode are introduced into a discharge vessel, the tip of the cathode having a radius of curvature R_{K} in mm and the distance between the cathode and the anode during operation e₀ being in mm and wherein a gas with a room temperature fill pressure P in bar is introduced into the discharge vessel, with it being ensured that

$$c = \sqrt{\frac{P \cdot {I}_{max}^{2}}{{e}_{0} \cdot {R}_{K}}} > 250 [ A \cdot \sqrt{\frac{bar}{{mm}^{2}}} ] .$$

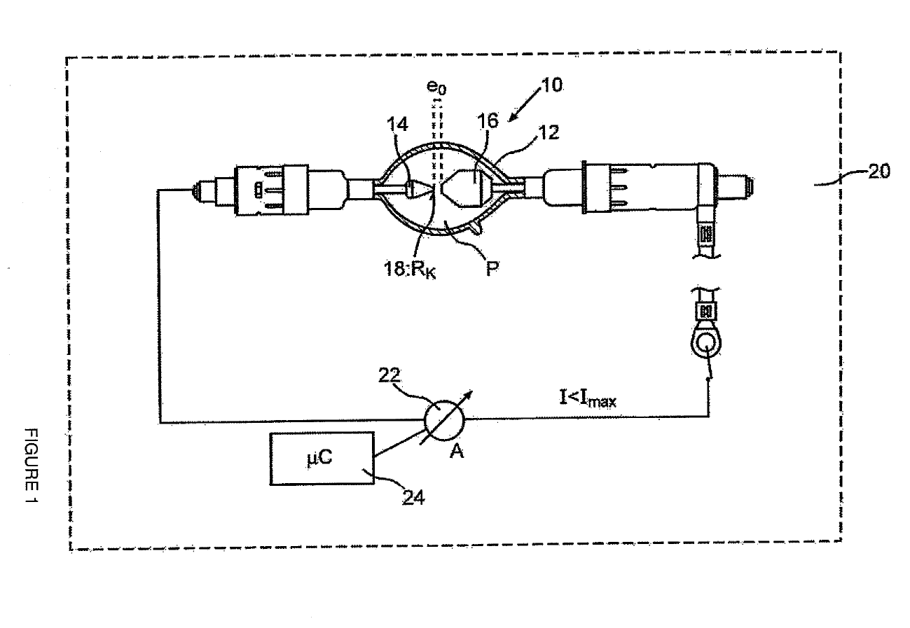

### TECHNICAL FIELD

The invention relates to a method for providing a high-pressure discharge lamp. Of most interest here is in particular a method for providing light by means of a high-pressure discharge lamp provided in such a way, wherein the main application field for this is a digital video projector.

In conventional projectors, light is transmitted onto a large area, for example a slide. Each subarea of this large area corresponds to part of the projected image.

In digital projectors, the individual images are combined pixel by pixel. In this case, light is provided for each pixel. Usually, a high-pressure discharge lamp, in particular a xenon high-pressure discharge lamp, is arranged in a reflector, which typically has the form of a partial ellipsoid. The lamp is arranged in such a way that the point of maximum luminance is approximately located at the first focal point of the partial ellipsoid, which focuses the light emitted by the lamp towards its second focal point. There, the light is output. Usually, a so-called integrator is provided in the region of the second focal point, said integrator intending to make the light beam homogeneous. The integrator is typically a quartz bar with a rectangular cross section, in which multiple total reflection of the light takes place, which then emerges in homogenized form from the quartz bar. An arrangement (array) of a large number of small mirrors is provided, for example, behind the quartz bar, it being possible for said mirrors to be tilted individually. The array of mirrors is activated in such a way that, in accordance with a control input, the individual pixels on a screen are illuminated or not. In the case of a digital video projector, it is therefore necessary to ensure that light with an extremely high luminance passes to the input of the integrator. Conventional xenon high-pressure discharge lamps do not have a sufficient maximum luminance to enable digital projection for convention cinema. The utilized flux on the cinema screen is too low. Until now, this has been remedied by providing xenon high-pressure discharge lamps with a particularly high power. An increased lamp power results not only in increased lamp costs and a shorter life but also in considerable thermal problems in the video projector. An extremely high amount of complexity is therefore involved in the cooling of the lamp and further projector components, which involves costs. Attempts have also already been made to configure the distance between the two electrodes (cathode and anode) of the high-pressure discharge lamp to be particularly small in order to achieve effective focusing of the light emerging from the arc produced onto the integrator. In the case of typical room temperature fill pressure values for the discharge gas (in the present example xenon), however, in this case the running in voltage and therefore also the power are simultaneously lowered, with the result that, at the same time, there is a loss of luminous intensity. If it is in turn desired to compensate for this loss of luminous intensity, it would be necessary to increase the current, which results in increased cathode burnback.

### DESCRIPTION OF THE INVENTION

The object of the present invention is to demonstrate a way of making it possible for digital video projectors to be used for the projection of cinema films, with the intention being in particular to demonstrate how the maximum luminance in three dimensions of the high-pressure discharge lamp can be increased.

The object is achieved by a method for providing a high-pressure discharge lamp having the steps as claimed in patent claim 1, a method for providing light by means of a high-pressure discharge lamp as claimed in patent claim 7 and a digital video projector as claimed in patent claim 9.

The method according to the invention for providing a high-pressure discharge lamp therefore comprises the following steps:
establishing a setpoint power of the high-pressure discharge lamp,
establishing an upper limit Iₘₐₓ in amperes for the current intensity of the current with which the high-pressure discharge lamp is intended to be operated with respect to the setpoint power,
constructing a high-pressure discharge lamp, wherein a cathode and an anode are introduced into a discharge vessel, the tip of the cathode having a radius of curvature R_{K} in mm and the distance between the cathode and the anode during operation (so-called hot electrode distance) e₀ being in mm and wherein a gas (in particular xenon) with a room temperature fill pressure P in bar is introduced into the discharge vessel (which is thereby closed), wherein the values (R_{K}, e₀ and P) are selected such that it is ensured that

$$c = \sqrt{\frac{P \cdot {I}_{max}^{2}}{{e}_{0} \cdot {R}_{K}}} > 250 [ A \cdot \sqrt{\frac{bar}{{mm}^{2}}} ] .$$

The invention is based on the knowledge of a mathematical relationship between the variables used in the formulae. That is to say that c is a degree which increases as the luminance of the high-pressure discharge lamp increases if Iₘₐₓ is applied to said high-pressure discharge lamp. Owing to the fact that the high-pressure discharge lamp has a greater luminance the greater the value c is, therefore, c is preferably greater than 275, particularly preferably greater than 300 and further preferably still greater than 320.

While the approaches known from the prior art substantially relate to already constructed high-pressure discharge lamps and have selected the current intensity in a manner appropriate for this, the invention makes it possible to first select the maximum current intensity and nevertheless to ensure sufficient luminance by virtue of the other variables R_{K}, e₀ and P being selected appropriately. Iₘₐₓ can be selected in particular such that the high-pressure discharge lamp and therefore the digital video projector with this high-pressure discharge lamp is not excessively heated such that, therefore, there are no longer any thermal problems. At the same time, the high-pressure discharge lamp can be operated with little wear. The maximum current can in particular have quite specifically the following values: Iₘₐₓ<105 A for a setpoint power of 1500 to 2500 W, Iₘₐₓ<115 A for a setpoint power of 2500 to 3500 W, Iₘₐₓ<130 A for a setpoint power of 3500 to 3800 W, Iₘₐₓ<160 A for a setpoint power of 3800 to 5000 W, Iₘₐₓ<180 A for a setpoint power of 5000 to 8000 W.

It is readily possible to select the values of R_{K}, e₀ and P in a manner which is appropriate for these maximum current intensities in such a way that the above variable c is greater than 250 and preferably greater than 275, 300 or even 320. For example, it is possible to select R_{K}<0.52; typically R_{K}=0.5 mm may be the case for a setpoint power of 7000 W. For setpoint powers of less than 5000 W, it may be the case that R_{K}<0.42 mm, for example R_{K}=0.4 mm.

P can be selected to be greater than 10 bar, even greater than 13.8 bar for setpoint powers of less than 5000 W, for example typically P=14 bar for setpoint powers of less than 5000 W.

The cathode distance e₀ can be selected depending on the setpoint power: e₀<2.8 mm may be true for a setpoint power of 1500 to 2500 W, e₀<3.8 mm for from 2500 to 3500 W, e₀<4.2 mm for from 3500 to 3800 W, e₀<5.2 mm for from 3800 to 5000 W, and e₀<7.0 mm for from 5000 to 8000 W. Care should be taken to ensure that these values apply to the hot electrode distance (electrode distance during operation). The cold electrode distance is 1 mm greater (estimated value), which is taken into consideration when constructing the lamp.

In the method according to the invention for providing light by means of a high-pressure discharge lamp, first the method for providing a high-pressure discharge lamp as described above is implemented. Then, a current I in amperes, where I<Iₘₐₓ, is applied to the high-pressure discharge lamp. In order for the maximum luminance to be particularly high, the following preferably applies

$$c ( I ) = \sqrt{\frac{P \cdot {I}^{2}}{{e}_{0} \cdot {R}_{K}}} > 250 [ A \cdot \sqrt{\frac{bar}{{mm}^{2}}} ]$$

(wherein, in particular, particularly preferably c(I)>275, particularly preferably >300, very particularly preferably >320, as long as it is ensured that I<Iₘₐₓ).

Typically, the current intensity I is selected to be considerably lower than Iₘₐₓ. By way of example, the following can apply for the abovementioned upper limits for Iₘₐₓ: 85 A<I<97 A for a setpoint power of 1500 to 2500 W, 93 A<I<107 A for a setpoint power of 2500 to 3500 W, 103 A<I<117 A for a setpoint power of 3500 to 3800 W, 113 A<I<140 A for a setpoint power of 3800 to 5000 W, 130 A<I<165 A for a setpoint power of 5000 to 8000 W.

The digital video projector according to the invention has a high-pressure discharge lamp which has been provided in accordance with the method according to the invention, i.e. a high-pressure discharge lamp in which the parameters of the radius of curvature of the cathode, the electrodistance and the room temperature fill pressure of the gas are selected in a manner which is appropriate for a setpoint power and a maximum current intensity in such a way that the luminous intensity is sufficiently high during operation of the high-pressure discharge lamp with a setpoint power and with a current below the maximum current intensity. The digital video projector according to the invention has a control unit for controlling the current which is applied to the high-pressure discharge lamp, wherein the control unit emits such control signals that a current with the current intensity I, where I<Iₘₐₓ, is always applied to the high-pressure discharge lamp during operation. This ensures safe operation of the digital video projector; in particular there are no excessive temperature increases.

### BRIEF DESCRIPTION OF THE DRAWING

The invention will be explained in more detail below with reference to an exemplary embodiment. The single FIGURE shows:
the construction of a high-pressure discharge lamp and, in addition, a schematic illustration of some component parts of a digital video projector.

### PREFERRED EMBODIMENT OF THE INVENTION

A high-pressure discharge lamp 10 has a tightly sealed discharge vessel 12, in which a discharge gas, in this case xenon, is located at room temperature (21°) under a pressure P. A cathode 14 and an anode 16 are located in the discharge vessel 12. The cathode 14 has a tip 18 with a radius of curvature R_{K}. The distance between the cathode tip 18 and the anode 16 is e₀.

The high-pressure discharge lamp 10 is designed for a predetermined setpoint power, with a maximum current intensity Iₘₐₓ being fixed for this setpoint power. The setpoint power and the maximum current intensity are selected such that operation of the high-pressure discharge lamp is ensured without excessive temperature increases arising. The variables P, e₀ and R_{K} are selected appropriately for Iₘₐₓ in such a way that

$$c = \sqrt{\frac{P \cdot {I}_{max}^{2}}{{e}_{0} \cdot {R}_{K}}} > 250 [ A \cdot \sqrt{\frac{bar}{{mm}^{2}}} ] .$$

The variable c is a measure of the maximum luminance of the lamp. In the case of non-digital video projectors, a value of less than 250 is achieved when using an identical measure. By virtue of the provision according to the invention of the high-pressure discharge lamp 10, it is possible to provide maximum luminance which cannot be provided in non-digital video projectors.

The high-pressure discharge lamp 10 is now used in a digital video projector 20 (illustrated schematically). The FIGURE does not show a reflector in which the high-pressure discharge lamp 10 is arranged and an integrator onto which the light emitted by the high-pressure discharge lamp 10 is focused before it is supplied to an array of mirrors.

The high-pressure discharge lamp 10 is fed in the digital video projector 20 by a power source 22. This power source is only intended to supply the high-pressure discharge lamp 10 with currents for which the following is true for the current intensity I: I<Iₘₐₓ. For this purpose, the power source 12 is activated by a control unit 24, which fixes the value of the current intensity I. The control unit 24, which can be in the form of a microcontroller, ensures that the current intensity Iₘₐₓ is not overshot. In order to ensure particularly high maximum luminance in three dimensions, the control unit 24 can also fix the current intensity I in such a way that

$$c ( I ) = \sqrt{\frac{P \cdot {I}^{2}}{{e}_{0} \cdot {R}_{K}}} > 250 [ A \cdot \sqrt{\frac{bar}{{mm}^{2}}} ] .$$

By suitably selecting the parameters e₀, R_{K} and P appropriately for Iₘₐₓ, a particularly high luminance is ensured without the setpoint power of the high-pressure discharge lamp 10 needing to be too high. By taking into consideration the above-mentioned formulae, it is therefore possible to provide a particularly high maximum luminance at a specific setpoint power. Conversely, if there is a desire for a predetermined maximum luminance, it is also possible to use a high-pressure discharge lamp 10 with a lower setpoint power than is otherwise the case.

The following table represents, for setpoint powers of the high-pressure discharge lamp 10, how the variables can be selected (current control range up to Iₘₐₓ, e₀, R_{K} and P) and c(I) produced when a current I<Iₘₐₓ is applied and the luminance:

| | Current | | | | | | |
|---|---|---|---|---|---|---|---|
| | control | | | Pressure | Current | | Maximum |
| Power | range | e₀ | R_{K} | P | I | c | luminance |
| [W] | {A} | [mm] | [mm] | [bar] | [A] | (I) | [kcd/cm\hat{ }2] |
| 2000 | 70-100 | 2.6 | 0.4 | 14.5 | 90 | 336.1 | 739.0 |
| 3000 | 80-110 | 3.5 | 0.4 | 15 | 100 | 327.3 | 915.0 |
| 3600 | 90-120 | 3.9 | 0.4 | 15 | 110 | 341.1 | 1002.0 |
| 4200 | 80-150 | 4.6 | 0.4 | 14 | 120 | 331.0 | 911.0 |
| 7000 | 110-165 | 6.7 | 0.5 | 10.5 | 160 | 283.3 | 953.0 |

1. A method for providing a high-pressure discharge lamp, the method comprising:
establishing a setpoint power of the high-pressure discharge lamp,
establishing an upper limit Iₘₐₓ in A for the current intensity of the current with which the high-pressure discharge lamp is intended to be operated with respect to the setpoint power, and
constructing a high-pressure discharge lamp, wherein a cathode and an anode are introduced into a discharge vessel, the tip of the cathode having a radius of curvature R_{K} in mm and the distance between the cathode and the anode during operation e₀ being in mm and wherein a gas with a room temperature fill pressure P in bar is introduced into the discharge vessel, with it being ensured that
$$c = \sqrt{\frac{P \cdot {I}_{max}^{2}}{{e}_{0} \cdot {R}_{K}}} > 250 [ A \cdot \sqrt{\frac{bar}{{mm}^{2}}} ] .$$

2. The method as claimed in claim 1,
wherein the high-pressure discharge lamp is constructed in such a way that c>275.

3. The method as claimed in claim 1,
wherein Iₘₐₓ<105 A for a setpoint power of 1500 to 2500 W
wherein Iₘₐₓ<115 A for a setpoint power of 2500 to 3500 W
wherein Iₘₐₓ<130 A for a setpoint power of 3500 to 3800 W
wherein Iₘₐₓ160 A for a setpoint power of 3800 to 5000 W
wherein Iₘₐₓ<180 A for a setpoint power of 5000 to 8000 W.

4. The method as claimed in claim 1,
wherein R_{K}<0.52 mm, for a setpoint power of less than 5000.

5. The method as claimed in claim 1,
wherein P>10 bar for a setpoint power of less than 5000 W.

6. The method as claimed in claim 1,
wherein e₀<2.8 mm for a setpoint power of 1500 to 2500 W
wherein e₀<3.8 mm for a setpoint power of 2500 to 3500 W
wherein e₀<4.2 mm for a setpoint power of 3500 to 3800 W
wherein e₀<5.2 mm for a setpoint power of 3800 to 5000 W
wherein e₀<7.0 mm for a setpoint power of 5000 to 8000 W.

7. A method for providing light by means of a high-pressure discharge lamp, the method comprising
implementing a method for providing a high-pressure discharge lamp, the method comprising:
establishing a setpoint power of the high-pressure discharge lamp,
establishing an upper limit Iₘₐₓ in A for the current intensity of the current with which the high-pressure discharge lamp is intended to be operated with respect to the setpoint power, and
constructing a high-pressure discharge lamp, wherein a cathode and an anode are introduced into a discharge vessel, the tip of the cathode having a radius of curvature R_{K} in mm and the distance between the cathode and the anode during operation e₀ being in mm and wherein a gas with a room temperature fill pressure P in bar is introduced into the discharge vessel, with it being ensured that
$$c = \sqrt{\frac{P \cdot {I}_{max}^{2}}{{e}_{0} \cdot {R}_{K}}} > 250 [ A \cdot \sqrt{\frac{bar}{{mm}^{2}}} ] .$$
applying a current with the current intensity I in A to the high-pressure discharge lamp, where
$$I < {I}_{max} and$$
$$c = \sqrt{\frac{P \cdot {I}_{max}^{2}}{{e}_{0} \cdot {R}_{K}}} > 250 [ A \cdot \sqrt{\frac{bar}{{mm}^{2}}} ] .$$

8. The method as claimed in claim 7,
wherein Iₘₐₓ<105 A for a setpoint power of 1500 to 2500 W
wherein Iₘₐₓ<115 A for a setpoint power of 2500 to 3500 W
wherein Iₘₐₓ<130 A for a setpoint power of 3500 to 3800 W
wherein Iₘₐₓ<160 A for a setpoint power of 3800 to 5000 W
wherein Iₘₐₓ<180 A for a setpoint power of 5000 to 8000 W, and
wherein 85 A<I<97 A for a setpoint power of 1500 to 2500 W
wherein 93 A<I<107 A for a setpoint power of 2500 to 3500 W
wherein 103 A<I<117 A for a setpoint power of 3500 to 3800 W
wherein 113 A<I<140 A for a setpoint power of 3800 to 5000 W
wherein 130 A<I≦165 A for a setpoint power of 5000 to 8000 W.

9. A digital video projector (20) with a high-pressure discharge lamp is provided in accordance with a method for providing a high-pressure discharge lamp, the method comprising:
establishing a setpoint power of the high-pressure discharge lamp, establishing an upper limit Iₘₐₓ in A for the current intensity of the current with which the high-pressure discharge lamp is intended to be operated with respect to the setpoint power, and
constructing a high-pressure discharge lamp, wherein a cathode and an anode are introduced into a discharge vessel, the tip of the cathode having a radius of curvature R_{K} in mm and the distance between the cathode and the anode during operation e₀ being in mm and wherein a gas with a room temperature fill pressure P in bar is introduced into the discharge vessel, with it being ensured that
$$c = \sqrt{\frac{P \cdot {I}_{max}^{2}}{{e}_{0} \cdot {R}_{K}}} > 250 [ A \cdot \sqrt{\frac{bar}{{mm}^{2}}} ] .$$
and with a controller configured to control the current which is applied to the high-pressure discharge lamp,
wherein the controller is further configured to emit control signals during operation such that a current with the current intensity I, where I<Iₘₐₓ, is always applied to the high-pressure discharge lamp during operation.

10. The method as claimed in claim 2,
wherein the high-pressure discharge lamp is constructed in such a way that c>300.

11. The method as claimed in claim 10,
wherein the high-pressure discharge lamp is constructed in such a way that c>320.

12. The method as claimed in claim 4,
wherein R_{K}<0.42 mm for a setpoint power of less than 5000.

13. The method as claimed in claim 5,
wherein P>13.8 bar for a setpoint power of less than 5000 W.
